(19) United States
(12) Patent Application Publication
(10) Pub. No.: US 2007/0297198 A1
(43) Pub. Date: Dec. 27, 2007

(54) Synchronous voltage modulation circuit for resonant power converter

(75) Inventor: Shun-Te Chang, Tamshui Chen (TW)

Correspondence Address: COOPER & DUNHAM, LLP, 1185 AVENUE OF THE AMERICAS, NEW YORK, NY, 10036, US

(73) Assignee: Acbel Polytech Inc.

(21) Appl. No.: 11/654,227

(22) Filed: Jan. 16, 2007

(30) Foreign Application Priority Data
Jun. 26, 2006 (TW) 095122922

(51) Int. Cl. H02M 3/335

(52) U.S. Cl. 363/17

(57) ABSTRACT

A synchronous voltage modulation circuit for resonance power converter has a resonance current extracting unit and at least one duty cycle modulation circuit. The resonance current extracting unit extracts the resonance current of the transformer for each duty cycle modulation circuit. The duty cycle modulation circuit controls the conduction period of the electronic switch on the secondary side of the transformer according to the power usage of the load connected to the power output and the resonance frequency of the resonance current on the transformer detected by the resonance current extracting unit. The conduction period increases or decreases symmetrically with respect to the central axis. The power converter output of the resonance power converter converter forms a closed loop control, thereby providing stable power to its load.

### BACKGROUND OF THE INVENTION

1. Field of the Invention

The invention relates to a circuit of a power converter and, in particular, to a synchronous output voltage modulation circuit for a resonant power converter that accurately controls the output voltage of the resonant power converter and provides power according to the power usage on the load connected to it.

2. Description of Related Art

Serial or parallel resonant power converters are mostly used on power converter to provide stable and high power to their output loads. However, early serial resonant converters only provide one set of power output. They often have a resonant controller like IC L6598 produced by ST Corporation on the primary side of the transformer to drive the power switches and control the electrical energy provided to the secondary side of the transformer. The input terminal of the resonant controller also connects to one output terminal of the power converter to form a closed loop control. Therefore, the electrical energy provided to the secondary side is controlled according to the variation on the power output by the resonant controller, so that a stable power is provided to the load.

For some applications that require multiple outputs of a power converter, it is more difficult for the above-mentioned resonant converter circuits to provide each output set with accurate and stable power at the same time. Therefore, a serial resonant converter circuit with multiple sets of power outputs has been proposed.

Please refer to FIG. 9 for a serial resonant power converter with multiple DC voltage outputs. It includes a transformer T1, a resonant controller 60, and an active power factor correction circuit (PFC) 52.

The transformer T1 has a primary side and several secondary sides for multiple outputs. Each of the secondary sides provides a set of power output. The secondary sides are connected in series with electronic switches QA˜QD to control the magnitudes of the corresponding power outputs on the secondary sides.

The resonant controller 60 is connected to the primary side of the transformer T1 through a half-bridge switch 53. Generally, the resonant controller 60 is only connected with one set of power output V1 to form a closed-loop control and stabilize its electrical power output. The other sets of power output are not connected with resonant controller 60, but the output values could still be controlled by proper arrangement of turn ratio on both sides of transformer T1 to provide different output voltages. Anyway, these output voltages may not be very accurate.

The active power factor correction circuit 52 is connected to the half-bridge switch 53 and to the AC power inputs L/N via a rectifier 51 and an EMI filter 50.

The above-mentioned serial resonant power converter mainly utilizes a transformer T1 with several secondary sides. A resonant controller 60 is used on the primary side to control the two transistors of the half-bridge switch 53 for providing a frequency modulating power to the primary side. In this case, each of the secondary sides of the transformer T1 generates an induction current. Due to the different numbers of coils on each secondary side, the two electronic switches QA/QD, QB/QC on each secondary side are controlled to provide different power outputs. According to this circuit diagram, the serial resonant power converter provides three sets of power outputs V1, V2 and V3 for three loads to use. However, the resonant controller 60 can only perform closed loop voltage stabilization depending on the feedback signal of output V1. Other power outputs V2, V3 on the secondary sides are open loop controlled by driving the electronic switches QA˜QD with a fixed duty cycle or conduction period. Generally, the resonant controller 60 only includes one feedback voltage input terminal. It adjusts the conduction period or duty cycle of the half-bridge switch 53 according to the power usage voltage variation of the load, thereby outputting the corresponding power for it. When the resonant controller drives the half-bridge switch 53 according to one of the three outputs (V1, V2, V3). The power outputs to the remaining two are also influenced and become inaccurate. Consequently, the prior serial resonant power converter that provides multiple sets of power outputs cannot ensure appropriate adjustment in each output according to the power usage of the corresponding loads connected to it.

### SUMMARY OF THE INVENTION

An object of the invention is to provide a synchronous voltage modulation circuit for power converter, so that each power output of the power converter provides a stable and accurate power to its load according to the power usage of the load.

To achieve the above object, the synchronous voltage modulation circuit has: a resonant current extracting unit for extracting the resonant current waveform of the transformer of the resonant power converter; and at least one duty cycle modulation circuit. The input portion of the duty cycle modulation circuit is connected to the output of the power converter and the output signal of the resonant current extracting unit. The output portion of the duty cycle modulation circuit is connected with the electronic switch on the secondary side.

Each of the power converter modulators first obtains the power converter state (power usage of the load) of the corresponding power output. With the resonance frequency of the resonance current waveform of the transformer obtained by the resonance current extracting unit, the conduction periods of the electronic switches on the secondary sides of the transformer are controlled concurrently. The conduction period of each electronic switch is increased or decreased symmetrically with respect to its central axis. The power output of each secondary side of the resonance power converter therefore adjusts itself according to the power usage of the load, achieving the goal of providing a stable power output to the load.

### BRIEF DESCRIPTION OF THE DRAWINGS

FIG. 1 is a block diagram of a synchronous voltage modulator for a resonance power converter according to a first embodiment of the present invention;

FIG. 2 is a block diagram of the synchronous voltage modulator in a second embodiment of the present invention;

FIG. 3 is a block diagram of the synchronous voltage modulator in a third embodiment of the present invention;

FIG. 4 shows the detailed circuit of FIG. 1;

FIG. 5 shows the detailed circuit of FIG. 2;

FIG. 6 shows the detailed circuit of FIG. 3;

FIGS. 7A to 7G show the current and voltage waveforms at various circuit nodes when the invention is connected to a heavy load power output;

FIGS. 8A to 8G show the current and voltage waveforms at various circuit nodes when the invention is connected to a light load power output; and

FIG. 9 is a circuit block diagram of a serial resonance power converter in the prior art.

### DETAILED DESCRIPTION OF THE PREFERRED EMBODIMENT

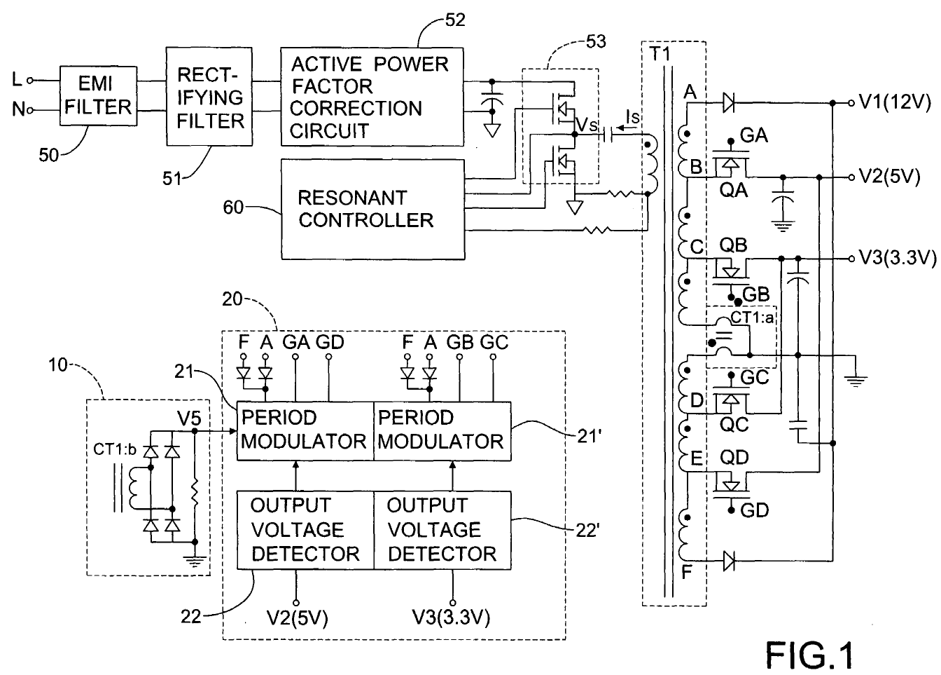

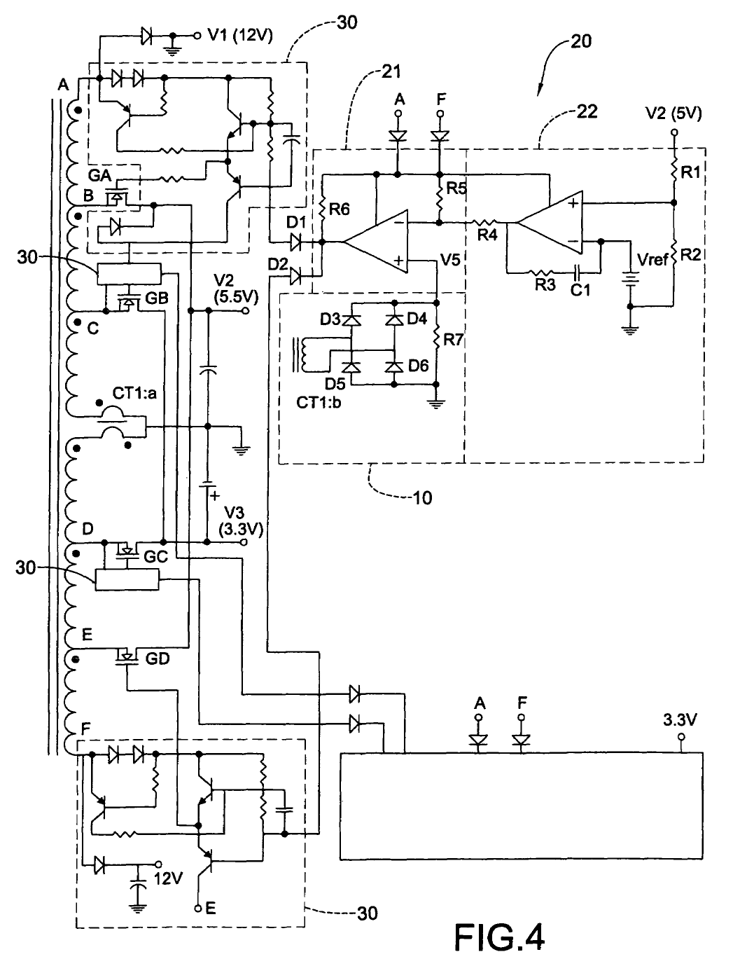

With reference to FIG. 1 and FIG. 4, FIG. 1 shows a first embodiment of the synchronous voltage modulation circuit for a resonant power converter in accordance with the present invention and FIG. 4 shows the detail of the circuit. In this embodiment, it is used in a serial resonant power converter that includes a transformer T1, several electronic switches QA˜QD, a resonant controller 60, a half-bridge switch 53, and an active power factor correction (PFC) circuit 52. The disclosed synchronous voltage modulation circuit has a resonant current extracting unit 10, and at least one duty cycle modulation circuit 20.

The resonant current extracting unit 10 extracts the resonant current on the transformer T1 of the resonant power converter. In this embodiment, the resonant current extracting unit 10 can be a current sensing element similar to a current transformer (CT) or a resistor, connected to a secondary side of the transformer T1 to extract its secondary side resonant current. Moreover, the resonant current extracting unit 10 used in this embodiment is a current transformer CT1 having at least two sets of coils CT1:a, CT1:b. The first coil CT1:a is coupled with the secondary side of the transformer T1. By transforming the current signal on the first coil CT1:a, the second coil CT1:b obtains the resonant current signal on the secondary side of the transformer T1 from its two ends. The current transformer CT1 is further connected with a full-wave rectifier and a resistor connected two output terminals of the full-wave rectifier in parallel to obtain a voltage signal V5 for representing the current value of the secondary side of the transformer T1. In this embodiment, the resonant current extracting unit 10 uses a current transformer. If the resonant current extracting unit 10 uses a resistor for sensing the current, the resistor can be connected to the primary or secondary side of the transformer to similarly obtain the resonant current on the transformer T1.

The duty cycle modulation circuit 20 has a period modulator 21 and an output voltage detector 22. Each of the duty cycle modulation circuit 20 is connected to the corresponding power output V2, V3 of the resonant power converter, the electronic switches QA˜QD on the secondary sides of the transformer T1, and the resonant current extracting unit 10. In general, one secondary side connected to the two electronic switches. The two electronic switches can be connected to a driver 30, as shown in FIG. 4. Therefore, the each of the duty cycle modulation circuit 20 is connected to the electronic switches of the corresponding secondary side through the driver 30, as shown in FIG. 4.

The number of duty cycle modulation circuit 20 matches with the number of power outputs V1, V2, V3 of the resonant power converter. In this embodiment, there are only two sets of duty cycle modulation circuit 20 connected to the two sets of power outputs V2, V3, respectively. The present invention is used in a power converter with several sets of power outputs. In particular, each duty cycle modulation circuit 20 has the period modulator 21 and the output voltage detector 22.

The period modulator 21 is connected to the resonant current extracting unit 10 and the electronic switches QA˜QD on the secondary sides of the transformer T1. The secondary side of the transformer T1 induces the current from the primary side. The power supplied to the single power output V2, V3 is determined with the help of the electronic switches QA˜QD. Therefore, the resonant current extracting unit 10 can extract the current variation on the load once it is connected to the secondary side of the transformer T1. The period modulator 21 controls the conduction period or duty cycle of the secondary side electronic switches QA˜QD of the transformer T1 according to the current or voltage variation on the output load.

The input terminals of the output voltage detector 22 are connected to the corresponding power output V2 and a reference voltage circuit, respectively. The output terminals are connected to the period modulator 21, so that the output voltage detector 22 detects the voltage variation on the power output V2. The output terminals of the output voltage detector 22 are connected to the period modulator 21. The output voltage detector 22 determines whether the current voltage of the power output terminal V2 is stable according to the voltage variation on the power output V2. The determination result of the output voltage detector 22 is further outputted to the period modulator 21.

As shown in FIG. 4, the output voltage detectors 22, 22′ are closed loop negative feedback circuit, mainly has an operational amplifier. The positive input terminal of the operational amplifier is connected to the corresponding power output V2. Its negative input terminal is connected to the output terminal of the operational amplifier and a reference voltage circuit to obtain a fixed reference voltage Vref. The reference voltage circuit is used to set a voltage range. Besides, the negative input terminal of the operational amplifier can be directly connected to the output terminal thereof.

FIG. 6 shows another embodiment of the duty cycle modulation circuit 20b. In this embodiment, the output voltage detector 22a includes a comparator LM339, whose positive input terminal is connected to the corresponding power output V2 and whose negative input terminal is connected to the reference voltage circuit. The reference voltage circuit consists of a voltage regulator TL431 and a voltage divider R3/R4. The voltage divider R3/R4 is connected to the output terminal of the voltage regulator TL431 to provide a fixed reference voltage Vref to the negative input terminal.

Further, to prevent the voltage output when the secondary side electronic switches QA/QD, QB/QC are conductive from feeding into and damaging the comparator LM339, a Schottky diode D1, D2 is inserted between the output terminal of the comparator LM339 and the driver 30 of each electronic switches QA/QD, QB/QC.

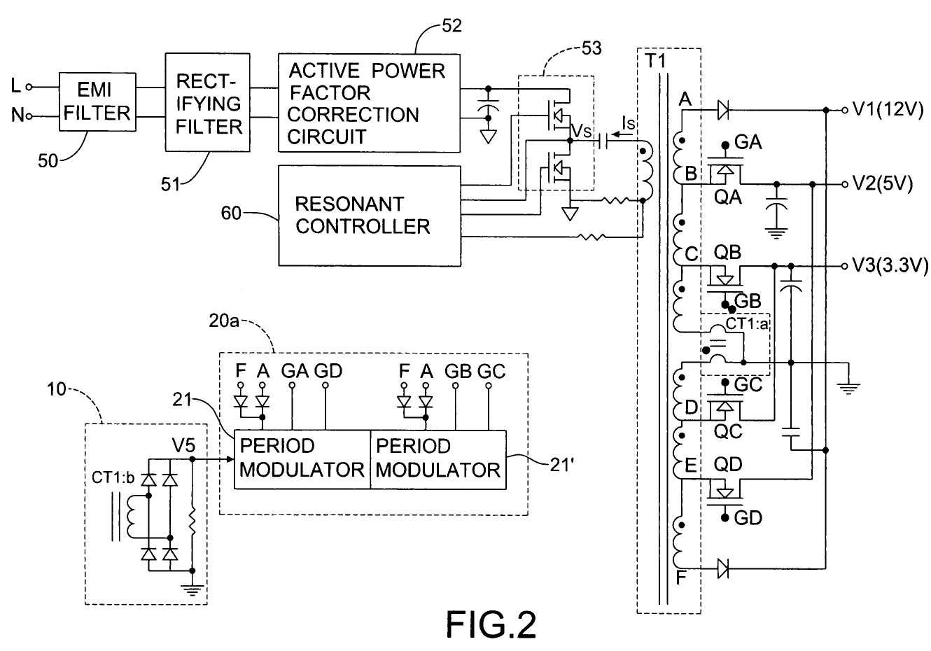

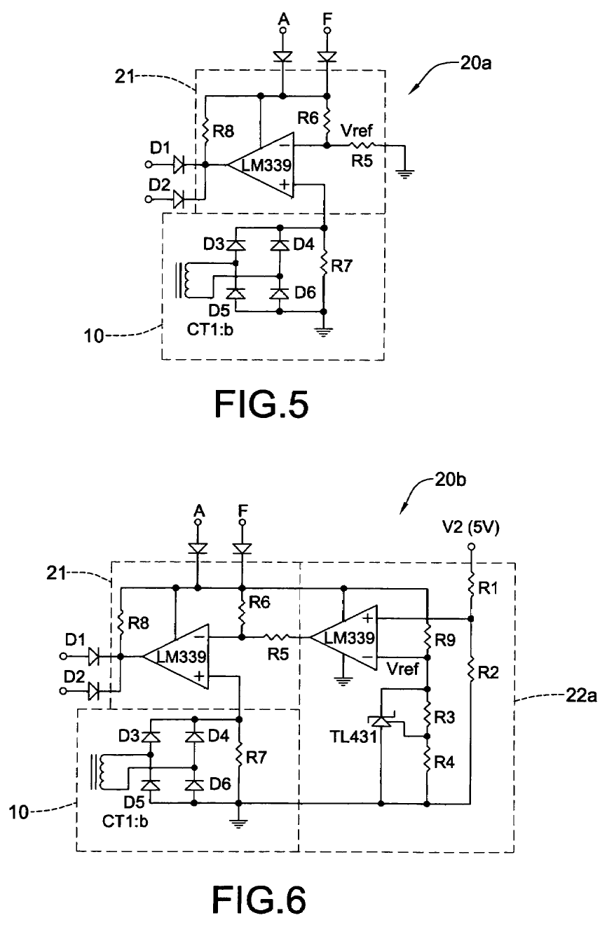

With reference to FIGS. 2 and 5, in the second embodiment of the invention, the synchronous voltage modulation circuit has a resonant current extracting unit 10 and at least one duty cycle modulation circuit 20a as well. However, the duty cycle modulation circuit 20a only includes a period modulator 21, which is a comparator LM339 whose both input terminals are connected to the output terminal of the resonant current extracting unit 10 and a fixed reference voltage Vref, respectively. Since the resonant current extracting current 10 extracts the secondary side resonant current, the resonant current varies with the power usage of the output load. It is directly compared with the reference voltage Vref by the comparator LM339, followed by outputting a control signal that varies with the resonant current. The control signal is output to the driver 30 of the secondary side electronic switches QA˜QD to modulate their conduction period or duty cycle.

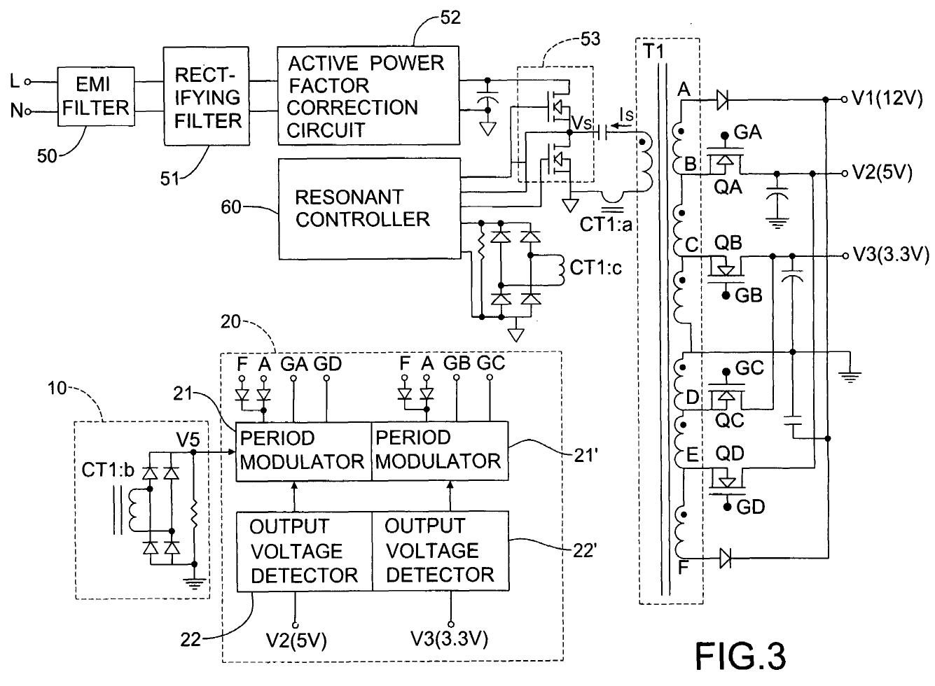

As shown in FIG. 3, the third embodiment of the disclosed synchronous voltage modulation circuit is similar to the first embodiment. However, the first coil CT1:a of the resonant current extracting unit 10 is coupled with the primary side of the transformer T1. The second coil CT1:b of the resonance current extracting unit 10 induces the current waveform from the primary side and is connected to two input terminals of a full-wave rectifier. A resistor is connected to the full-wave rectifier in parallel to provide a variable voltage V5 followed by the induction current from the second coil CT1:b.

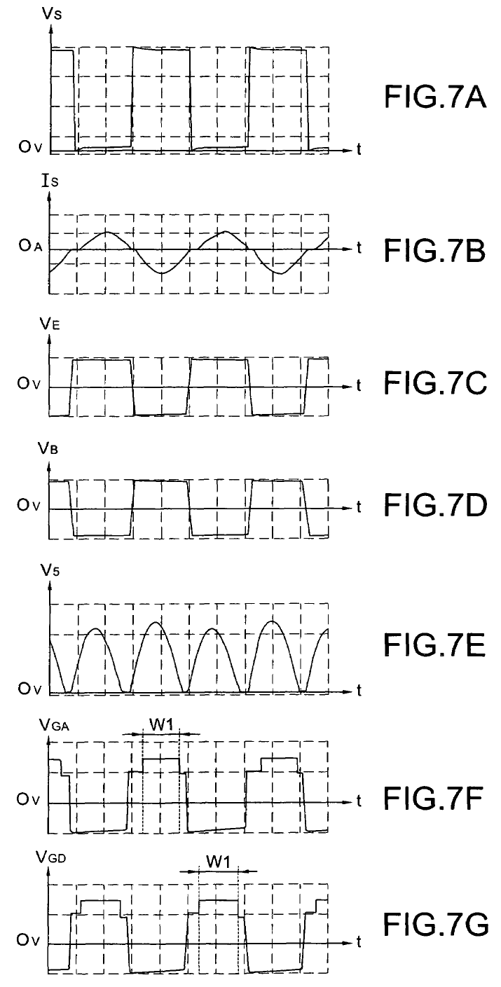

Please refer simultaneously to FIGS. 1 and 7. The plots in FIG. 7 show the voltage or current waveforms at various circuit nodes when the output load in the first embodiment of FIG. 1 becomes a heavy load. FIGS. 7A and 7B show the voltage and current waveforms on the primary side of the transformer T1. FIGS. 7C and 7D show the voltage variation at point B and E on the secondary side. FIG. 7E shows the current waveform of the secondary side resonant current obtained by the resonant current extracting unit 10. It is seen in the drawings that because the second voltage output V2 has a heavy load, the provided power output is increased whereas the voltage output V2 tend to decrease. When the duty cycle modulation circuit 20 receives the waveform of the uprising current, it converts to form a corresponding uprising voltage waveform V5. After comparing with the decreasing voltage on the second voltage output V2, the duty cycle modulation circuit 20 controls the driver of the electronic switches QA, QD to adjust the conduction periods of the two secondary side switches. As shown in FIGS. 7F and 7G, the conduction periods W1 of the two switches QA, QD are broadened symmetrically with respect to its own central axis. A larger power is output to the second voltage output V2, bringing the potential voltage on the second voltage output V2 back to normal. In other words, the voltage output V2 is under accurate control.

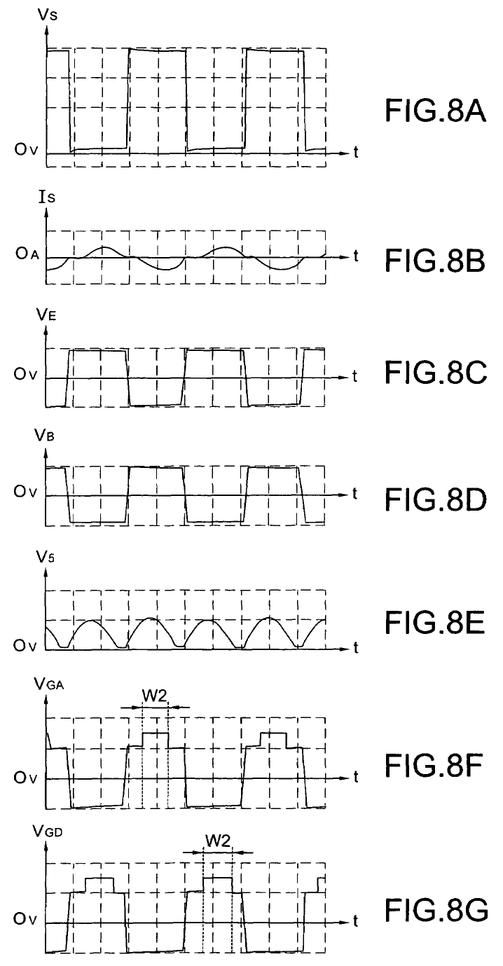

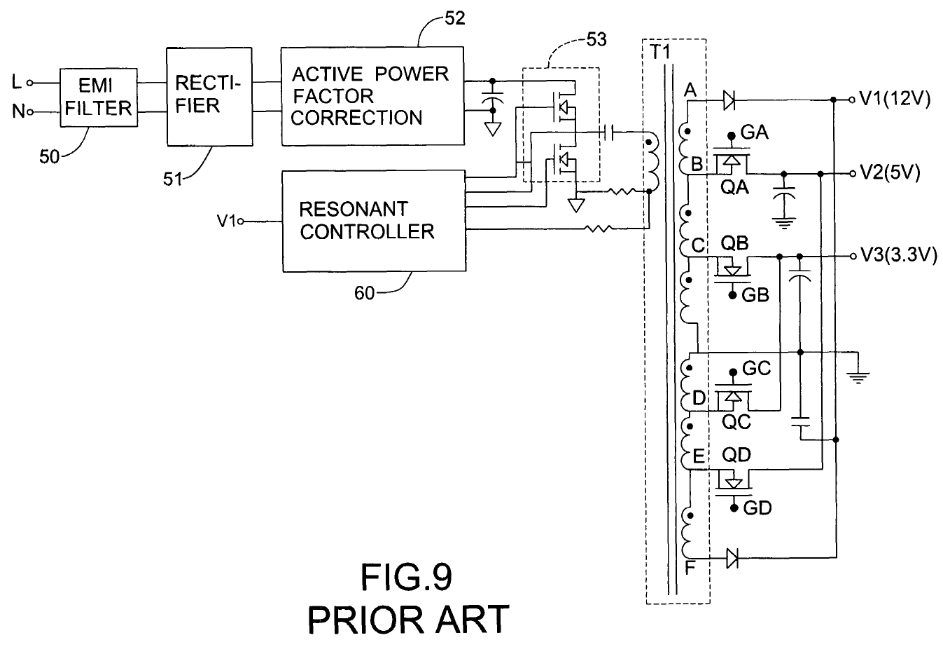

Please refer simultaneously to FIGS. 1 and 8. The plots in FIG. 8 show the voltage or current waveforms at various circuit nodes when the output load in the first embodiment of FIG. 1 becomes a light load. FIGS. 8A and 8B show the voltage and current waveforms on the primary side of the transformer T1. FIGS. 8C and 8D show the voltage variation at point B and E on the secondary side. FIG. 8E shows the current waveform of the secondary side resonant current obtained by the resonant current extracting unit 10. It is seen in the drawings that because the second voltage output V2 has a light load, the provided power output is decreased whereas the voltage output V2 tend to increase. When the duty cycle modulation circuit 20 receives the waveform of the descending current, it converts to form a corresponding descending voltage waveform V5. After comparing with the increasing voltage on the second voltage output V2, the duty cycle modulation circuit 20 controls the driver of the electronic switches QA, QD to adjust the conduction periods of the two secondary side switches. As shown in FIGS. 8F and 8G, the conduction periods W2 of the two switches QA, QD are narrowed symmetrically with respect to its own central axis. A smaller power is output to the second voltage output V2, bringing the potential voltage on the second voltage output V2 back to normal. In other words, the voltage output V2 is under accurate control.

In summary, the disclosed synchronous voltage modulation circuit provides a closed loop control for each power output of the resonant power converter, so that each power output terminal adjusts its output according to the power usage of its load. Therefore, the loads connected to the resonant power converter with multiple power outputs can obtain stable power supplies.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A power converter, comprising:
a transformer having a primary side and at least one secondary side;
at least one electronic switch each of which is connected to the corresponding secondary side;
a resonant controller connected to the primary side;
at least one power output connected to output of the secondary side;
a resonant current extracting unit adapted to couple to the transformer for extracting the resonant current waveform of the transformer; and
at least one duty cycle modulation circuit, each of which is connected to the corresponding power output, and to the resonant current extracting unit, and to the corresponding electronic switches to control a conduction period of the corresponding electronic switches according to voltage of the corresponding power output and the resonant current extracting unit;
wherein each of the at least one duty cycle modulation circuit comprises:
a period modulator, which is connected to the corresponding electronic switches on the secondary side of the transformer; and
an output voltage detector, whose input terminal is connected to the corresponding power output to obtain a voltage variation thereon, and whose output terminal is connected to the period modulator for outputting a relative voltage for the power output to the period modulator, wherein the period modulator further controls the conduction period of each electronic switch according to the relative voltage for the power output.

2. The power converter as claimed in claim 1, wherein the output voltage detector is a negative feedback circuit comprised of an operational amplifier, comprising
two input terminals, wherein one is connected to the corresponding power output; and
an output terminal connected to one of input terminals of the operational amplifier and the corresponding electronic switch on the secondary side.

3. The power converter as claimed in claim 1, wherein the output voltage detector comprises a negative feedback circuit comprised of an operational amplifier, which comprises:
two input terminals, wherein one is connected to the corresponding power output; and
an output terminal of the operational amplifier connected to the other input terminals of the operational amplifier, a reference voltage circuit used to provide a fixed reference voltage, and the corresponding electronic switch on the secondary side.

4. The power converter as claimed in claim 1, wherein the output voltage detector comprises a comparator whose one input terminal is connected to the corresponding power output, whose other terminal is connected to a reference voltage circuit used to provide a fixed reference voltage, and whose input terminals are connected to input terminals of the period modulator.

5. The power converter as claimed in claim 3, wherein the reference voltage circuit comprises a voltage regulator and a voltage divider, the voltage divider being connected to an input of the voltage regulator for providing the fixed reference voltage to the input terminal.

6. The power converter as claimed in claim 4, wherein the reference voltage circuit comprises a voltage regulator and a voltage divider, the voltage divider being connected to and input of the voltage regulator for providing the fixed reference voltage to the input terminal.

7. The power converter as claimed in claim 2, wherein the period modulator comprises a comparator whose two input terminals are connected respectively to the output terminal of the output voltage detector and the resonance current extracting unit and whose output terminal is connected to the corresponding electronic switches of the secondary side.

8. The power converter as claimed in claim 3, wherein the period modulator comprises a comparator whose two input terminals are connected respectively to the output terminal of the output voltage detector and the resonance current extracting unit and whose output terminal is connected to the corresponding electronic switches of the secondary side.

9. The power converter as claimed in claim 4, wherein the period modulator comprises a comparator whose two input terminals are connected respectively to the output terminal of the output voltage detector and the resonance current extracting unit and whose output terminal is connected to the corresponding electronic switches of the secondary side.

10. The power converter as claimed in claim 5, wherein the period modulator comprises a comparator whose two input terminals are connected respectively to the output terminal of the output voltage detector and the resonance current extracting unit and whose output terminal is connected to the corresponding electronic switches of the secondary side.

11. The power converter as claimed in claim 6, wherein the period modulator comprises a comparator whose two input terminals are connected respectively to the output terminal of the output voltage detector and the resonance current extracting unit and whose output terminal is connected to the corresponding electronic switches of the secondary side.

12. The power converter as claimed in claim 10, wherein the output terminal of the period modulator is connected to a driver of the corresponding electronic switches via a Schottky diode.

13. The power converter as claimed in claim 11, wherein the output terminal of the period modulator is connected to a driver of the corresponding electronic switches via a Schottky diode.

14. The power converter as claimed in claim 1, wherein the resonant current extracting unit is adapted to couple to the primary side of the transformer.

15. The power converter as claimed in claim 1, wherein the resonant current extracting unit is adapted to couple to the corresponding secondary side of the transformer.

16. The power converter as claimed in claim 14, wherein the resonant current extracting unit comprises:
a first coil connected in series to the transformer for extracting the resonance current thereon; and
a second coil, which induces the resonant current on the first coil to produce an inductance current, converts the inductance current using a full-wave rectifier and a resistor connected in parallel to output terminals to provide a corresponding voltage, and outputs the voltage to the input terminal of the period modulator.

17. The power converter as claimed in claim 15, wherein the resonance current extracting unit comprises:
a first coil connected in series to the transformer r for extracting the resonance current thereon; and
a second coil, which induces the resonance current on the first coil to produce an inductance current, converts the inductance current using a full-wave rectifier and a resistor connected in parallel to output terminals to provide a corresponding voltage, and outputs the voltage to the input terminal of the period modulator.

18. The power converter as claimed in claim 14, wherein the resonant current extracting unit comprises a resistor connected to the transformer for outputting the resonance current thereof to the period modulator.

19. The power converter as claimed in claim 15, wherein the resonant current extracting unit comprises a resistor connected to the transformer for outputting the resonance current thereof to the period modulator.

20. A power converter, comprising:
a transformer having a primary side and at least one secondary side;
at least one electronic switch each of which is connected to the corresponding secondary side;
a resonant controller connected to the primary side;
at least one power output connected to output of the secondary side;
a resonant current extracting unit adapted to couple to the transformer for extracting the resonant current waveform of the transformer; and
at least one duty cycle modulation circuit, each of which is connected to the corresponding power output, and to the resonant current extracting unit, and to the corresponding electronic switches to control a conduction period of the corresponding electronic switches according to voltage of the corresponding power output and the resonant current extracting unit; wherein each of the at least one duty cycle modulation circuit comprises a period modulator, which is connected to the corresponding electronic switches on the secondary side of the transformer.

21. The power converter as claimed in claim 20, wherein the period modulator comprises a comparator whose two input terminals are connected respectively to the output terminal of the output voltage detector and the resonance current extracting unit, and whose output terminal is connected to the corresponding electronic switches of the secondary side.

22. The power converter as claimed in claim 20, wherein the resonant current extracting unit comprises:
a first coil connected in series to the transformer for extracting the resonance current thereon; and
a second coil, which induces the resonant current on the first coil to produce an inductance current, converts the inductance current using a full-wave rectifier and a resistor connected in parallel to output terminals to provide a corresponding voltage, and outputs the voltage to the input terminal of the period modulator.

23. The power converter as claimed in claim 21, wherein the resonant current extracting unit comprises:
a first coil connected in series to the transformer for extracting the resonance current thereon; and
a second coil, which induces the resonant current on the first coil to produce an inductance current, converts the inductance current using a full-wave rectifier and a resistor connected in parallel to output terminals to provide a corresponding voltage, and outputs the voltage to the input terminal of the period modulator.

24. The power converter as claimed in claim 20, wherein the resonant current extracting unit comprises a resistor connected to the transformer for outputting the resonance current thereof to the period modulator.

25. The power converter as claimed in claim 21, wherein the resonant current extracting unit comprises a resistor connected to the transformer for outputting the resonance current thereof to the period modulator.

26. The power converter as claimed in claim 21, wherein the output terminal of the comparator is connected to a driver of the corresponding electronic switches via a Schottky diode.
